(19) United States
(12) Patent Application Publication
(10) Pub. No.: US 2026/0244550 A1
(43) Pub. Date: Aug. 20, 2026

(54) Data Clustering for Machine Learning Model-Based Anomaly Prediction

(71) Applicant: Disney Enterprises, Inc., Burbank, CA (US)

(72) Inventors: Thiago Borba Onofre, Winter Garden, FL (US); Michael Tschanz, Orlando, FL (US)

(21) Appl. No.: 19/054,687

(22) Filed: Feb. 14, 2025

(51) Int. Cl. G06F 11/34; G06F 11/32

(52) U.S. Cl. CPC G06F 11/3447; G06F 11/324

(57) ABSTRACT

A system includes a processor and a memory storing software code and a trained machine learning (ML) model. The software code is executed to receive global sensor data generated by sensors used to monitor a plurality of apparatuses and, for a first apparatus, extract from the global sensor data, data generated by a first subset of sensors associated with the first apparatus. The software code is further executed to identify, using the global sensor data, other data generated within a respective predetermined time interval of the expected timing of at least one of the first subset of sensors, process the data and the other data to provide performance data for the first apparatus, predict, using the trained ML model and the performance data, whether the first apparatus is operating anomalously, and output, when the first apparatus is operating anomalously, a notification including a visual representation of the performance data.

### BACKGROUND

Many industrial apparatuses are interconnected systems-of-systems having designs that are increasingly complicated and are susceptible to malfunction or failure for many different reasons. The larger a system-of-systems based apparatus is, the more difficult, costly and inefficient it can become to identify and troubleshoot the sources of anomalous apparatus operation. Conventional solutions for anticipating apparatus malfunctions and failures have relied upon the deep knowledge base of highly experienced system engineers, which, due to the heavy reliance of those solutions on the expertise of particular individuals, are brittle and ultimately untenable. Moreover, as the amount of monitoring data required to adequately profile the operating state of a system-of-systems based apparatus grows with the increasing complexity of such an apparatus, human review and interpretation of that data becomes ever more impracticable. Consequently, there is a need in the art for an automated solution for diagnosing the operational states of complex apparatuses and accurately predicting situations in which those apparatuses are likely to malfunction or fail.

### BRIEF DESCRIPTION OF THE DRAWINGS

FIG. 1 shows an exemplary system for performing data clustering for machine learning (ML) model-based anomaly prediction, according to one implementation;

FIG. 2 shows a more detailed diagram of the portable device shown in FIG. 1, according to one implementation;

FIG. 3 shows an exemplary cluster of sensor data used to perform ML model-based anomaly prediction for an apparatus, according to one implementation;

FIG. 4A shows an exemplary visual representation of performance data generated based on sensor data included in the cluster of sensor data shown in FIG. 3, according to one implementation;

FIG. 4B shows another exemplary visual representation of performance data generated based on sensor data included in the cluster of sensor data shown in FIG. 3, according to one implementation;

FIG. 4C shows yet another exemplary visual representation of performance data generated based on sensor data included in the cluster of sensor data shown in FIG. 3, according to one implementation; and

FIG. 5 shows a flowchart presenting an exemplary method for performing data clustering for ML model-based anomaly prediction, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As stated above, many industrial apparatuses are interconnected systems-of-systems having designs that are increasingly complicated and are susceptible to malfunction or failure for many different reasons. The larger a system-of-systems based apparatus is, the more difficult, costly and inefficient it can become to identify and troubleshoot the sources of anomalous apparatus operation. Conventional solutions for anticipating apparatus malfunctions and failures have relied upon the deep knowledge base of highly experienced system engineers, which, due to the heavy reliance of those solutions on the expertise of particular individuals, are brittle and ultimately untenable. Moreover, and as also stated above, as the amount of monitoring data required to adequately profile the operating state of a system-of-systems based apparatus grows with the increasing complexity of such an apparatus, human review and interpretation of that data becomes ever more impracticable.

The present application discloses systems and methods for performing data clustering for machine learning (ML) model-based anomaly prediction that address and overcome the drawbacks and deficiencies in the conventional art by disclosing an automated solution for diagnosing the operational states of complex apparatuses and accurately predicting situations in which those apparatuses are likely to malfunction or fail. The present solution recognizes that even complex apparatuses are designed to follow an expected operating pattern that is programmed. Sensors may be outfitted on, in, or adjacent to apparatus components that allow for these operating patterns to be tracked through data.

The present data clustering for ML model-based anomaly prediction systems and methods advance the state-of-the-art by identifying and extracting data relevant to the operating state of an apparatus from a dataset, which may be or include a binary time series dataset including billions of data points, for example, processing that relevant data to generate performance data for the apparatus, and using a trained ML model to predict whether the apparatus is operating anomalously based on that performance data in real-time with respect to generation of the dataset. Furthermore, in some implementations, the present solution for performing data clustering for ML model-based anomaly prediction may include performing an intervention when an anomalous operating state of an apparatus is predicted. Such an intervention may include sounding an alarm at the apparatus, shutting down operation of the apparatus, or modifying the performance of the apparatus, to name a few examples.

It is noted that the present ML model-based anomaly prediction solution is distinct from dimensionality reduction approaches, such as Principle Component Analysis (PCA) for example, in which the original data is reduced into a smaller subset. By contrast to PCA, in which data is compressed for analysis, the anomaly prediction solution disclosed by the present application effectively expands collected data by clustering data points through the identification of meaningful correspondences between sensor data produced by different sensors, based on timing. As a result, the present anomaly prediction solution can provide better insight into the operational state of a physical apparatus than when a dimensionality reduction analytical framework such as PCA is applied.

It is further noted that due to the complexity of the apparatuses for which anomaly prediction is performed by the systems and methods disclosed herein, i.e., the number and interrelatedness of the components and subsystems comprised by each apparatus, reliance upon a trained ML model to accurately predict anomalous operation is essential. Thus, due to the complexity of the operation of the apparatuses subject to the present anomaly prediction solution, the present proactively predictive method is incapable of being performed as a mental process by a human mind, even with the aid of a general purpose computer. That is to say, while conventional attempts to predict anomalous operation by complex apparatuses may result in such predictions lagging the generation of performance data by hours, days or weeks, or even being performed as a diagnosis rather than prediction, in a forensic process post hoc to malfunction or failure of the system, the present ML model-based solution improves the technical field of mechanical troubleshooting and maintenance by advantageously enabling corrective interventions in real-time before apparatus failures or significant malfunctions occur. For example, a notification predicting anomalous operation by an apparatus may be output by the present system and according to the present method within up to ten seconds of receipt by the system of performance data for the apparatus, while a corrective intervention may be initiated within seconds or minutes of outputting the notification.

As defined in the present application, the expression “ML model” refers to a computational model for making predictions based on patterns learned from samples of data or training data. Various learning algorithms can be used to map correlations between input data and output data. These correlations form the computational model and can be used to make future predictions on new input data. Such a predictive model may include one or more logistic regression models, Bayesian models, artificial neural networks (NNs) such as Transformers, large-language models (LLMs), or multimodal foundation models, to name a few examples. In various implementations, ML models may be trained as classifiers and may be utilized to perform image processing, audio processing, natural-language processing, and other inferential analyses. A “deep neural network,” in the context of deep learning, may refer to a NN that utilizes multiple hidden layers between input and output layers, which may allow for learning based on features not explicitly defined in raw data. As used in the present application, a feature identified as a NN refers to a deep neural network.

It is further noted that the performance data provided by the systems and using the methods disclosed in the present application can be used to produce interpretable visualizations identifying where and when the operation of components of an apparatus are deviating from expectations. In addition, the present anomaly prediction solution may advantageously be implemented as automated systems and methods. As used in the present application, the terms “automation,” “automated” and “automating” refer to systems and processes that do not require the participation of a human system operator. Thus, the methods described in the present application may be performed under the control of hardware processing components of the disclosed systems.

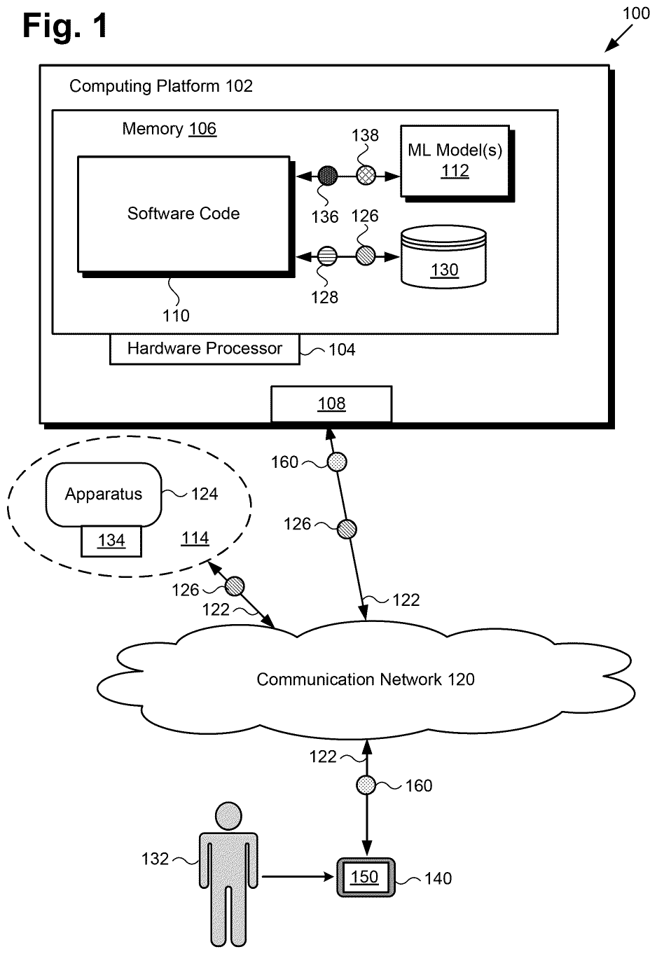

FIG. 1 shows exemplary system 100 for performing data clustering for ML model-based anomaly prediction, according to one implementation. As shown in FIG. 1, system 100 includes computing platform 102 having hardware processor 104, memory 106 implemented as a computer-readable non-transitory storage medium, and transceiver 108. According to the present exemplary implementation, memory 106 stores software code 110, one or more trained ML models 112 (hereinafter “trained ML model(s) 112”) and sensor database 130 including a plurality of database entries each associating a respective subset of a plurality of sensors with one of plurality of apparatuses 114.

With respect to trained ML model(s) 112, it is noted that in some implementations trained ML model(s) 112 may include one or more statistical models based on Interquartile Range (IQR), shape analytics (e.g., kurtosis and/or wavelets), or auto-regression, to name a few examples. Alternatively, or in addition, trained ML model(s) 112 may include one or more K-Means models, K-Nearest Neighbors (KNN) models, deep learning NNs (DNNs) such as Long Short-Term Memory (LSTM) models, Density-Based Spatial Clustering of Applications with Noise (DBSCAN) models, Gaussian Mixture models, Spectral clustering models, Time Series Transformer models, or any combination thereof.

As further shown in FIG. 1, system 100 is implemented within a use environment that includes plurality of apparatuses 114 including apparatus 124, one or more sensors 134 (hereinafter “sensor(s) 134”) used to monitor apparatus 124, and communication network 120 providing network communication links 122 communicatively coupling system 100 with plurality of apparatuses 114 and portable device 140 including display 150. Also shown in FIG. 1 is system user 132 utilizing portable device 140 to interact with system 100, as well as global sensor data 126 including data generated by all active sensors of the plurality of sensors used to monitor plurality of apparatuses 114, clustered sensor data 128, performance data 136 provided as input to trained ML model(s) 112, prediction 138 provided by trained ML model(s) 112 based on performance data 136 and notification 160 output by system 100 when an anomalous operating state of one or more of plurality of apparatuses 114 is predicted. It is noted that notification 160 may include a visual representation of performance data 136 on which the prediction of anomalous operation is based.

System user 132 may be an engineer or programmer tasked with evaluating the operational performance of one or more of plurality of apparatuses 114. Moreover, in some use cases, global sensor data 126 may describe a past operation of plurality of apparatuses 114, and may be utilized to perform a forensic analysis of a historical performance of one or more of plurality of apparatuses 114. However, in other use cases, global sensor data 126 may be received dynamically while one or more of plurality of apparatuses 114 is/are in operation. In some implementations, as shown in FIG. 1, global sensor data 126 may be received via communication network 120 and network communication links 122. It is noted that in various implementations, plurality of apparatuses 114 may include one or more of a baggage claim carousel or carousels, an automated warehouse or warehouses, a theme park attraction or attractions, a vehicle assembly line machine or machines, an aviation system or systems, a HVAC system or systems, an engine or engines, manufacturing equipment, or a computer server or servers, to name a few examples.

The plurality of sensors, including sensor(s) 134, used to monitor plurality of apparatuses 114 may include one or more sensors affixed to plurality of apparatuses 114, internal to plurality of apparatuses 114, situated adjacent to any of plurality of apparatuses 114 within a venue housing any of plurality of apparatuses 114, or situated adjacent to any of plurality of apparatuses 114 in an outdoor space occupied by any of plurality of apparatuses 114. That plurality of sensors including sensor(s) 134 may include one or more cameras, one or more audio microphones, one or more temperature sensors, one or more pressure sensors, one or more vibration sensors, one or more chemical sensors, one or more timing devices, or any combination thereof. The plurality of sensors including sensor(s) 134 may be configured to detect one or more of visual images, sounds, vibrations, heat, pressure, time duration, air quality or smells (aromas).

Although the present application refers to software code 110, trained ML model(s) 112 and sensor database 130 as being stored in memory 106 for conceptual clarity, more generally, memory 106 may take the form of any computer-readable non-transitory storage medium. The expression “computer-readable non-transitory storage medium,” as defined in the present application, refers to any medium, excluding a carrier wave or other transitory signal, that provides instructions to hardware processor 104 of computing platform 102. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, internal and external hard drives, optical discs, RAM, programmable read-only memory (PROM), erasable PROM (EPROM) and FLASH memory.

Moreover, in some implementations, system 100 may utilize a decentralized secure digital ledger in addition to memory 106. Examples of such decentralized secure digital ledgers may include a blockchain, hashgraph, directed acyclic graph (DAG), and Holochain® ledger, to name a few. In use cases in which the decentralized secure digital ledger is a blockchain ledger, it may be advantageous or desirable for the decentralized secure digital ledger to utilize a consensus mechanism having a proof-of-stake (PoS) protocol, rather than the more energy intensive proof-of-work (PoW) protocol.

It is further noted that although FIG. 1 depicts software code 110, trained ML model(s) 112 and sensor database 130 as being stored together in a single instance of memory 106, that representation is merely provided as an aid to conceptual clarity. More generally, system 100 may include one or more computing platforms 102, such as computer servers for example, which may be co-located, or may form an interactively linked but distributed system, such as a cloud-based system, for instance. As a result, hardware processor 104 and memory 106 may correspond to distributed processor and memory resources within system 100, and one or more of software code 110, trained ML model(s) 112 and sensor database 130 may be stored remotely from one another on the distributed memory resources of system 100. Furthermore, although FIG. 1 depicts trained ML model(s) 112 and sensor database 130 as components of system 100 stored in memory 106, in some implementations one or more of sensor database 130 and trained ML model(s) may be remote resources accessible by system 100 via communication network 120 and network communication links 122.

Hardware processor 104 may include a plurality of hardware processing units, such as one or more central processing units, one or more graphics processing units, and one or more tensor processing units, one or more field-programmable gate arrays (FPGAs), custom hardware for machine learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 110, from memory 106, while a GPU may be implemented to reduce the processing overhead of the CPU by performing computationally intensive graphics or other processing tasks. A TPU is an application-specific integrated circuit (ASIC) configured specifically for artificial intelligence (AI) applications such as ML modeling.

Transceiver 108 of system 100 may be implemented as a wireless communication unit configured for use with one or more of a variety of wireless communication protocols. For example, transceiver 108 may include a fourth generation (4G) wireless transceiver and/or a 5G wireless transceiver. In addition, or alternatively, transceiver 108 may be configured for communications using one or more of Wireless Fidelity (Wi-Fi®), Worldwide Interoperability for Microwave Access (WiMAX®), Bluetooth®, Bluetooth® low energy (BLE), ZigBee®, radio-frequency identification (RFID), near-field communication (NFC), and 60 GHz wireless communications methods.

In some implementations, computing platform 102 may correspond to one or more web servers, accessible over a packet-switched network such as the Internet, for example. Alternatively, computing platform 102 may correspond to one or more computer servers supporting a private wide area network (WAN), local area network (LAN), or included in another type of limited distribution or private network. In addition, or alternatively, in some implementations, system 100 may utilize a local area broadcast method, such as User Datagram Protocol (UDP) or Bluetooth®, for instance. Furthermore, in some implementations, system 100 may be implemented virtually, such as in a data center. For example, in some implementations, system 100 may be implemented in software, or as virtual machines. Moreover, in some implementations, communication network 120 may be a high-speed network suitable for high performance computing (HPC), for example a 10 GigE network or an Infiniband network.

Portable device 140 may take the form of a smartphone, or any other suitable portable computing system that implements data processing capabilities sufficient to provide a user interface, and implement the functionality attributed to portable device 140 herein. For example, in other implementations, portable device 140 may take the form of a tablet computer, laptop computer, or an augmented reality (AR) or virtual reality (VR) device, for example, providing display 150. Display 150 may take the form of a liquid crystal display (LCD), a light-emitting diode (LED) display, an organic light-emitting diode (OLED) display, a quantum dot (QD) display, or any other suitable display screen that performs a physical transformation of signals to light.

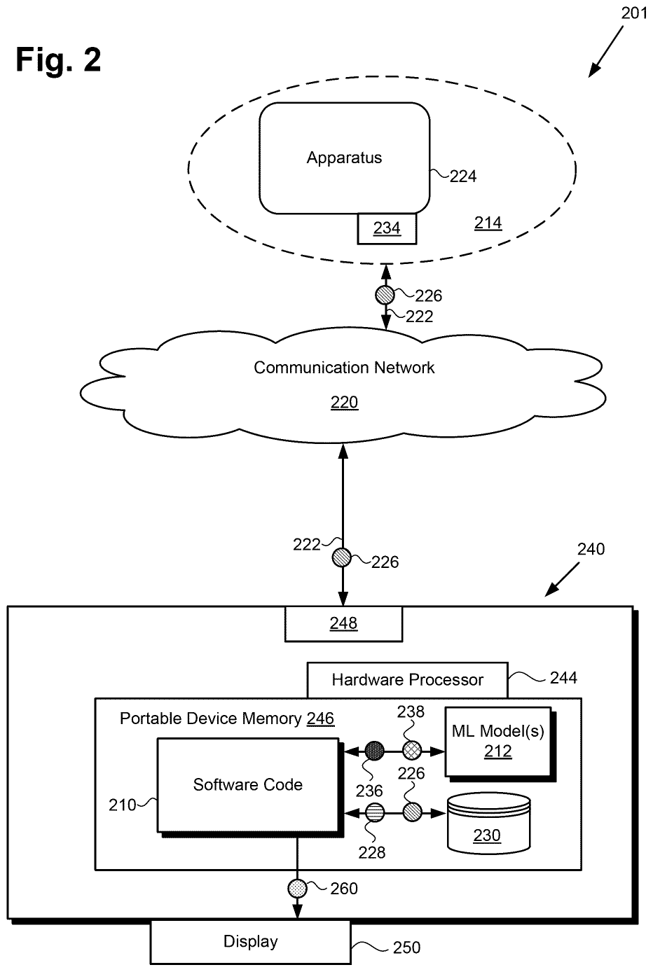

FIG. 2 shows a more detailed diagram of portable device 240, according to one implementation. As shown in FIG. 2, portable device 240 includes hardware processor 244, transceiver 248, display 250 and portable device memory 246 implemented as a computer-readable non-transitory storage medium storing software code 210, one or more trained ML models 212 (hereinafter “trained ML model(s) 212”) and sensor database 230.

As further shown in FIG. 2, portable device 240 is utilized in use environment 201 that includes plurality of apparatuses 214 including apparatus 224, one or more sensors 234 (hereinafter “sensor(s) 234”) used to monitor apparatus 224, and communication network 220 providing network communication links 222 communicatively portable device 240 with plurality of apparatuses 214. Also shown in FIG. 2 are global sensor data 226 including data generated by all active sensors of the plurality of sensors used to monitor plurality of apparatuses 214, clustered sensor data 228, performance data 236 provided as input to trained ML model(s) 212, prediction 238 provided by trained ML model(s) 212 based on performance data 236 and notification 260 output by portable device 240 when an anomalous operating state of one or more of plurality of apparatuses 214 is predicted.

Plurality of apparatuses 214 including apparatus 224, sensor(s) 234 and communication network 220 providing network communication links 222 correspond respectively in general to plurality of apparatuses 114 including apparatus 124, sensor(s) 134 and communication network 120 providing network communication links 122, in FIG. 1. Consequently, plurality of apparatuses 214 including apparatus 224, sensor(s) 234 and communication network 220 providing network communication links 222 may share any of the characteristics attributed to respective plurality of apparatuses 114 including apparatus 124, sensor(s) 134 and communication network 120 providing network communication links 122, and vice versa. That is to say, in various implementations, like plurality of apparatuses 114, plurality of apparatuses 214 may include one or more of a baggage claim carousel or carousels, an automated warehouse or warehouses, a theme park attraction or attractions, a vehicle assembly line machine or machines, an aviation system or systems, a HVAC system or systems, an engine or engines, manufacturing equipment, or a computer server or servers, to name a few examples, while the plurality of sensors, including sensor(s) 234, used to monitor plurality of apparatuses 214 may include one or more sensors affixed to plurality of apparatuses 114, internal to plurality of apparatuses 114, situated adjacent to any of plurality of apparatuses 114 within a venue housing any of plurality of apparatuses 114, or situated adjacent to any of plurality of apparatuses 114 in an outdoor space occupied by any of plurality of apparatuses 114. Moreover, like plurality of sensors 114 including sensor(s) 134, plurality of sensors 214 including sensor(s) 234 may include one or more cameras, one or more audio microphones, one or more temperature sensors, one or more pressure sensors, one or more vibration sensors, one or more chemical sensors, one or more timing devices, or any combination thereof.

In addition, global sensor data 226, clustered sensor data 228, performance data 236, prediction 238 and notification 260, in FIG. 2, correspond respectively in general to global sensor data 126, clustered sensor data 128, performance data 136, prediction 138 and notification 160, in FIG. 1. As a result, global sensor data 226, clustered sensor data 228, performance data 236, prediction 238 and notification 260 may share any of the characteristics attributed to respective global sensor data 126, clustered sensor data 128, performance data 136, prediction 138 and notification 160 by the present disclosure, and vice versa.

Portable device 240 and display 250 correspond respectively in general to portable device 140 and display 150, in FIG. 1. Thus, portable device 240 and display 250 may share any of the characteristics attributed to respective portable device 140 and display 150 by the present disclosure, and vice versa. For example, like portable device 140, portable device 240 may take the form of a smartphone, tablet computer, laptop computer, or an AR or VR device, for example, providing display 250. In addition, like display 150, display 250 may take the form of an LCD, LED display, OLED display, or QD display. Moreover, although not shown in FIG. 1, portable device 140 may include features corresponding respectively to hardware processor 244, transceiver 248 and portable device memory 246 storing software code 210, trained ML model(s) 212 and sensor database 230.

Transceiver 248 may be implemented as a wireless communication unit configured for use with one or more of a variety of wireless communication protocols. For example, transceiver 248 may include a 4G wireless transceiver and/or a 5G wireless transceiver. In addition, or alternatively, transceiver 248 may be configured for communications using one or more of Wi-Fi®, WiMAX®, Bluetooth®, BLE, ZigBee®, RFID, NFC, and 60 GHz wireless communications methods.

Hardware processor 244 of portable device 240 may include multiple hardware processing units, such as one or more CPUs, one or more GPUs, one or more TPUs, and one or more FPGAs, as those features are defined above.

Software code 210 corresponds in general to software code 110, in FIG. 1, and can perform all of the operations attributed to software code 110 by the present disclosure. In other words, in implementations in which hardware processor 244 of portable device 240 executes software code 210 stored locally in portable device memory 246 to utilize trained ML model(s) 212 and sensor database 230, portable device 240 may perform any of the actions attributed to system 100 by the present disclosure. Thus, in some implementations, system 100 may be embodied in portable device 140/240.

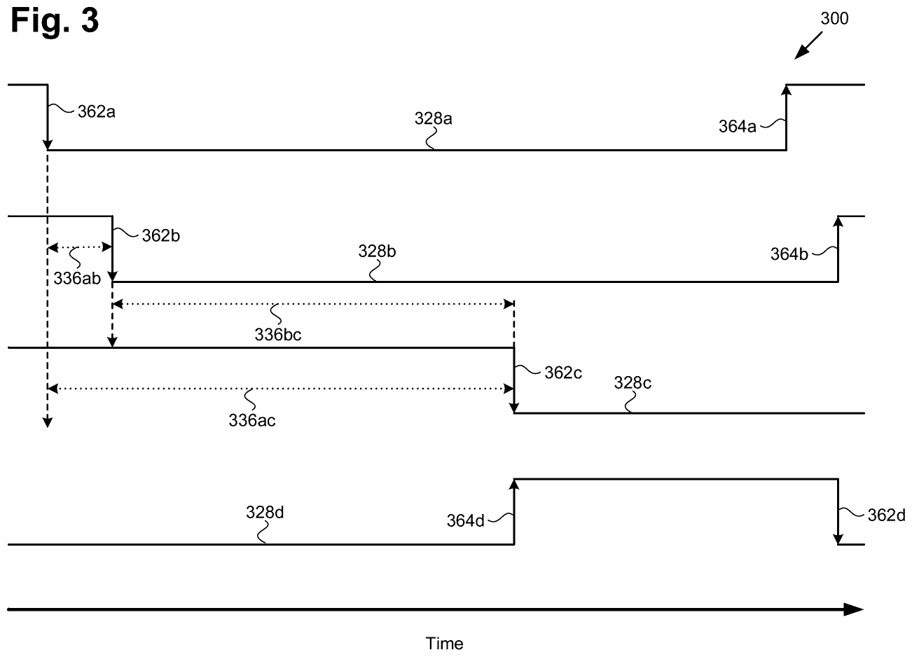

FIG. 3 shows diagram 300 showing clustered sensor data 328a, 328b, 328c and 328d (hereinafter “clustered sensor data 328a-328d”) for an exemplary cluster of sensor data used to perform ML model-based anomaly prediction for an apparatus, according to one implementation. According to the exemplary implementation shown in FIG. 3, the sensors producing clustered sensor data 328a-328d are digital sensors and each of clustered sensor data 328a-328d represents a respective binary time series generated by a single sensor. It is noted that although FIG. 3 depicts sensor data produced by digital sensors, in various implementations the present anomaly prediction solution may be adapted to use sensor data produced by analog sensors, or sensor data that is a combination of digital and analog sensor data. It is further noted that although FIG. 3 depicts sensor data produced by four different sensors, that representation is merely provided as an example. In various use cases, sensor data from any desired plurality of sensors may be clustered to perform the novel and inventive ML model-based anomaly prediction approach disclosed in the present application. For example, in other use cases, sensor data for as few as two sensors may be clustered to perform ML model-based anomaly prediction, sensor data for three sensors may be clustered to perform ML model-based anomaly prediction, or sensor data for more than four sensors may be clustered to perform ML model-based anomaly prediction.

Regarding the identification of what sensor data to include in clustered sensor data 328a-328d and what sensor data to omit, that identification may be performed manually, i.e., sensors to be clustered could be identified by a system user, or may be performed in an automated process. When performed in an automated process, the identification of which sensors to cluster may be based on a moving window approach using different time intervals to identify sensor data that includes a rising edge or a falling edge within a predetermined time interval of a rising edge or falling edge of sensor data produced by another sensor. That process could be performed for a plurality of different time intervals, such as 0.1s, 0.5s, 1.0s, 10s, and 30s, for example, and a cluster based one on or more of rising edge to rising edge, rising edge to falling edge, falling edge to falling edge, and falling edge to rising edge could be determined. A plurality of clusters of sensors could be determined in this way.

Clustered sensor data 328a-328d corresponds in general to clustered sensor data 128/228 in FIGS. 1 and 2, and each of those corresponding features may share any of the characteristics attributed to any of those corresponding features by the present disclosure. According to the exemplary use case shown in FIG. 3, clustered sensor data 328a, 328b and 328c (hereinafter “clustered sensor data 328a-328c”) are generated by different sensors used to monitor the same apparatus, while clustered sensor data 328d is generated by a sensor used to monitor a different apparatus, but is clustered with clustered sensor data 328a-328c due to a timing correspondence by clustered sensor data 328d with clustered sensor data 328b and 328c.

By way merely of example, and referring to FIGS. 1, 2 and 3 in combination, let it be assumed that clustered sensor data 328a-328c are generated by sensor(s) 134/234 used to monitor apparatus 124/224 in the form of a theme park ride, and that clustered sensor data 328d is generated by a sensor used to monitor another of plurality of apparatuses 114/214, which may be another theme park ride or any other type of apparatus. Let it further be assumed that falling edge 362a of clustered sensor data 328a corresponds to a command to close entry gates to a ride vehicle, while rising edge 364a corresponds to a command to open those gates. In addition, let it also be assumed that falling edge 362b and rising edge 364b of clustered sensor data 328b correspond to the respective closing and opening of a first entry gate of the ride vehicle, and that falling edge 362c of clustered sensor data 328c corresponds to the closing of a last entry gate of the ride vehicle.

Although clustered sensor data 328d may be unrelated to the operation of apparatus 124/224, it is noted that rising edge 364d of clustered sensor data 328d coincides with falling edge 362c of clustered sensor data 328c, and that falling edge 362d of clustered sensor data 328d coincides with rising edge 364b of clustered sensor data 328b. Also shown in FIG. 3 are delta time 336ab between the command to close the entry gates to the ride vehicle, the command corresponding to falling edge 362a, and falling edge 362b indicating closure of the first entry gate of the ride vehicle; delta time 336ac between the command to close entry gates to the ride vehicle corresponding to falling edge 362a and falling edge 362c indicating closure of the last entry gate of the ride vehicle; and delta time 336bc between falling edge 362b indicating closure of the first entry gate of the ride vehicle and falling edge 362c indicating closure of the last entry gate of the ride vehicle.

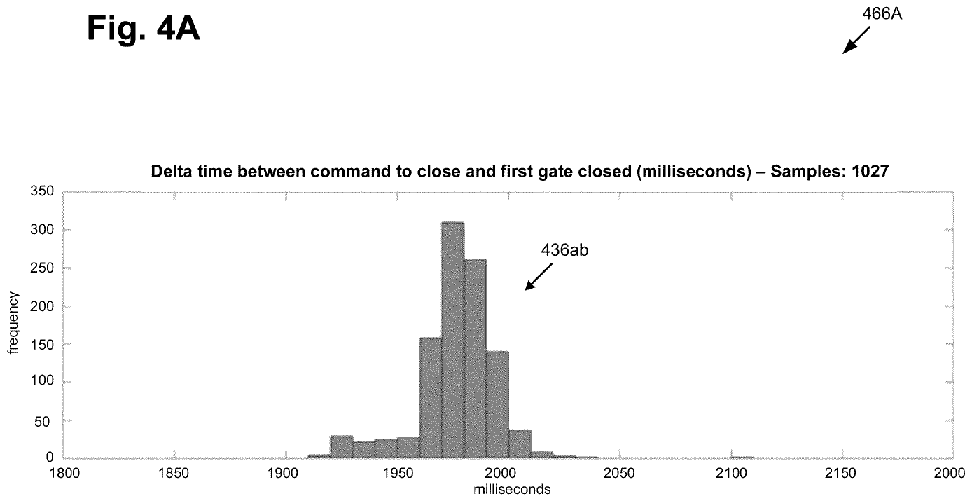

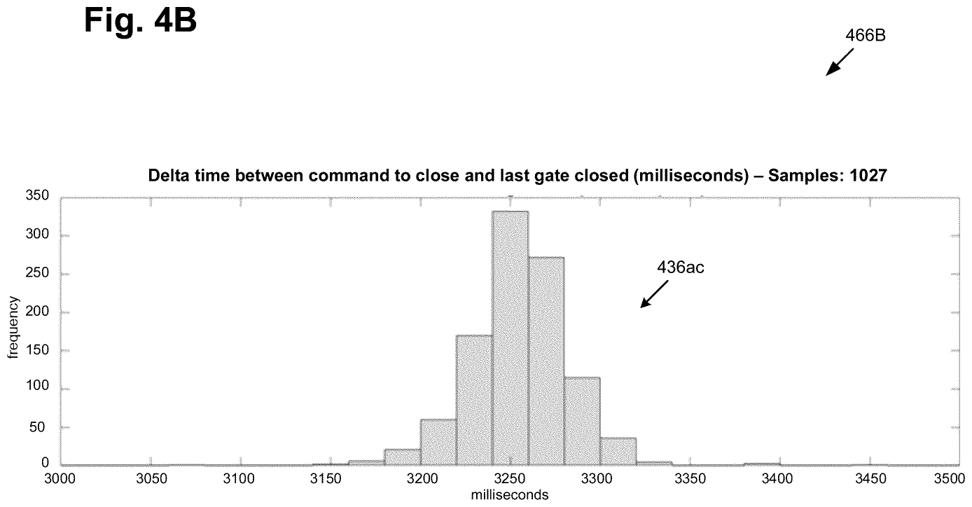

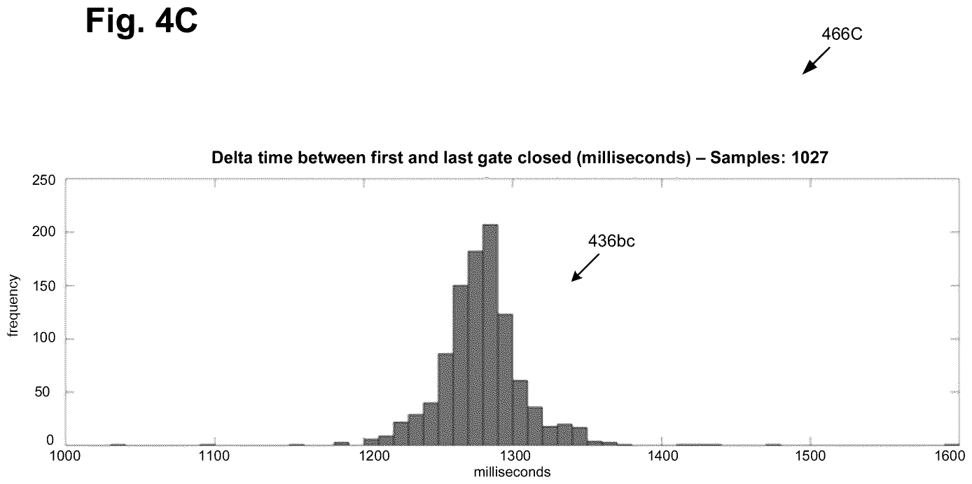

FIGS. 4A, 4B and 4C show exemplary visual representation 466A, 466B and 466C of respective performance data 436ab, 436ac and 436bc generated based on the cluster of clustered sensor data shown in FIG. 3, according to one implementation. Referring to FIGS. 3 and 4A in combination, performance data 436ab is the statistical distribution of variations in delta time 336ab (in milliseconds) over a plurality of commands to close entry gates to the ride vehicle and responsive first entry gate closures of the ride vehicle. Analogously, and referring to FIGS. 3 and 4B in combination, performance data 436ac is the statistical distribution of variations in delta time 336ac over a plurality of commands to close entry gates to the ride vehicle and responsive last entry gate closures of the ride vehicle, while performance data 436bc, shown in FIG. 4C, is the statistical distribution of variations in delta time 336bc between the first entry gate closure of the ride vehicle in response to the command to close entry gates to the ride vehicle and the last entry gate closure of the ride vehicle in response to the same command to close entry gates to the ride vehicle for a plurality of such closures.

It is noted that performance data 436ab, 436ac and 436bc, collectively, correspond in general to performance data 136/236, in FIGS. 1 and 2, and also correspond respectively in general to delta times 336ab, 336ac and 336bc, in FIG. 3. It is further noted that the specific instantiations of performance data represented by performance data 436ab, 436ac and 436bc, in FIGS. 4A, 4B and 4C are provided merely as examples. In some use cases, in addition to, or as alternatives to one or more of performance data 436ab, 436ac and 436bc, performance data 136/236 may include variations in delta times between falling edge 362c of clustered sensor data 328c and rising edge 364d of clustered sensor data 328d (shown to coincide in FIG. 3), variations in delta times between rising edge 364b of clustered sensor data 328b and falling edge 362d of clustered sensor data 328d (also shown to coincide in FIG. 3), or any other metric determined to be relevant to predicting anomalous operation by apparatus 124/224.

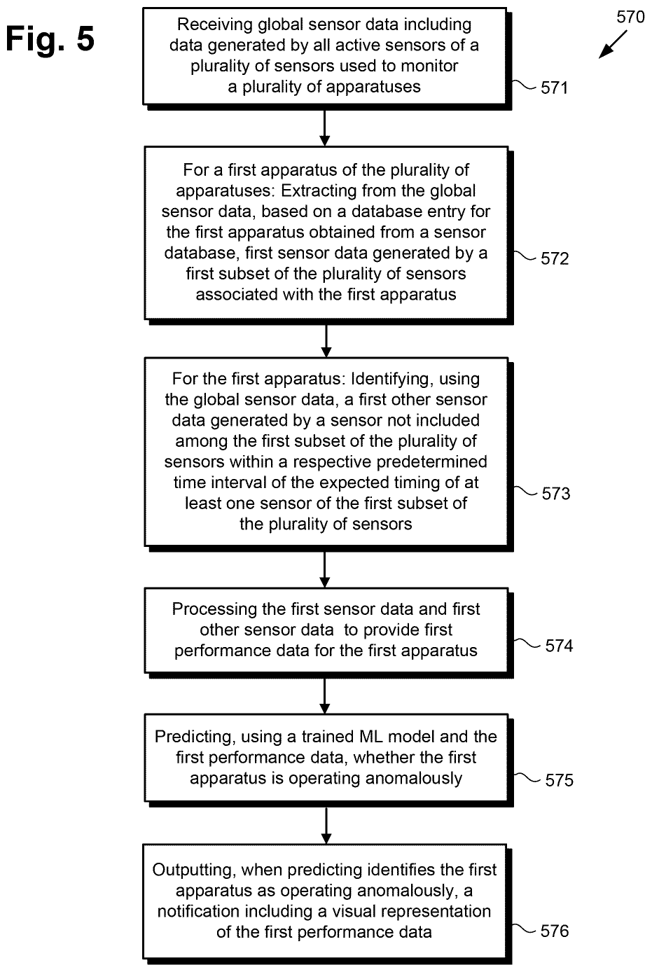

The functionality of system 100 and portable device 140/240, software code 110/210, trained ML model(s) 112/212 and sensor database 130/230, shown in FIGS. 1 and 2, will be further described by reference to FIG. 5. FIG. 5 shows flowchart 570 presenting an exemplary method for performing data clustering for ML model-based anomaly prediction, according to one implementation. With respect to the method outlined in FIG. 5, it is noted that certain details and features have been left out of flowchart 570 in order not to obscure the discussion of the inventive features in the present application.

Referring to FIG. 5, with further reference to FIGS. 1 and 2, flowchart 570 includes receiving global sensor data 126/226 generated by all active sensors of a plurality of sensors, including sensor(s) 134/234, used to monitor plurality of apparatuses 114/214 (action 571). As noted above, in various implementations plurality of apparatuses 114/214 may include one or more of a baggage claim carousel or carousels, an automated warehouse or warehouses, a theme park attraction or attractions, a vehicle assembly line machine or machines, an aviation system or systems, a HVAC system or systems, an engine or engines, manufacturing equipment, or a computer server or servers, to name a few examples.

As noted above by reference to global sensor data 126, in FIG. 1, in some use cases, global sensor data 126/226 may describe a past operation of plurality of apparatuses 114/214, and may be utilized to perform a forensic analysis of a historical performance of one or more of plurality of apparatuses 114/214. However, in other use cases, global sensor data 126/226 may be received dynamically while one or more of plurality of apparatuses 114/214 is/are in operation and may be used to predict whether one or more of plurality of apparatuses 114/214 is in need of maintenance to correct anomalous operation by that/those one or more of plurality of apparatuses 114/214. It is noted that global sensor data 126/226 may be or include a plurality of binary time series each generated by a respective one of the active sensors of the plurality of sensors used to monitor plurality of apparatuses 114/214, and that global sensor data 126/226 may include tens of millions, hundreds of millions, or a billion or billions of data points

In some implementations, as shown in FIG. 1, global sensor data 126 may be received from active sensors of the plurality of sensors used to monitor plurality of apparatuses 114 via communication network 120 and network communication links 122, in action 571, by software code 110, executed by hardware processor 104 of system 100. In other implementations, as shown in FIG. 2, global sensor data 226 may be received from active sensors of the plurality of sensors used to monitor plurality of apparatuses 214 via communication network 220 and network communication links 222, in action 571, by software code 210, executed by hardware processor 244 of portable device 240.

As further noted above, the plurality of sensors, including sensor(s) 134/234, used to monitor plurality of apparatuses 114/214 may include one or more digital and/or analog sensors affixed to plurality of apparatuses 114/214, internal to plurality of apparatuses 114/214, or situated adjacent to any of plurality of apparatuses 114/214 within a venue housing any of apparatuses 114, or situated adjacent to any of plurality of apparatuses 114 in an outdoor space occupied by any of plurality of apparatuses 114. That plurality of digital and/or analog sensors including sensor(s) 134/234 may include one or more cameras, one or more audio microphones, one or more temperature sensors, one or more pressure sensors, one or more vibration sensors, one or more chemical sensors, one or more timing devices, or any combination thereof.

Referring to FIG. 5 in combination with FIGS. 1, 2 and 3, flowchart 570 further includes, for a first apparatus of plurality of apparatuses 114/214 (the first apparatus hereinafter referred to as “apparatus 124/224”), extracting from global sensor data 126/226, based on a database entry for apparatus 124/224 obtained from sensor database 130/230, first sensor data (hereinafter “clustered sensor data 328a-328c”) generated by a first subset of the plurality of sensors used to monitor plurality of apparatuses 114/214 that are associated with apparatus 124/224 (the first subset of sensors associated with apparatus 124/224 hereinafter referred to as “sensor(s) 134/234”) (action 572). In some implementations, clustered sensor data 328a-328c may be extracted from global sensor data 126, in action 572, by software code 110, executed by hardware processor 104 of system 100. However, in other implementations, clustered sensor data 328a-328c may be extracted from global sensor data 226, in action 572, by software code 210, executed by hardware processor 244 of portable device 240.

Continuing to refer to FIG. 5 in combination with FIGS. 1, 2 and 3, flowchart 570 further includes, for apparatus 124/224, identifying, using global sensor data 126/226, a first other sensor data (hereinafter “clustered sensor data 328d”) generated by a sensor of the plurality of sensors used to monitor apparatuses 114/214 not included among sensor(s) 134/234 within a respective predetermined time interval of an expected timing of at least one sensor of sensor(s) 134/234 (action 573). As noted above by reference to FIG. 3, clustered sensor data 328d is included with clustered sensor data 328a-328c in clustered sensor data 128/228 in FIGS. 1 and 2 due to the timing relationship between rising edge 364d of clustered sensor data 328d with falling edge 362c of clustered sensor data 328c, and the timing relationship between falling edge 362d of clustered sensor data 328d and rising edge 364b of clustered sensor data 328b.

It is noted that although the FIG. 3 depicts rising edge 364d of clustered sensor data 328d as coinciding with falling edge 362c of clustered sensor data 328c, and falling edge 362d of clustered sensor data 328d as coinciding with rising edge 364b of clustered sensor data 328b, those timing relationships are merely provided as examples. More generally, a relevant timing relationship between clustered sensor data 328d and one or more of clustered sensor data 328a-328c may exist where a rising or falling edge of clustered sensor data 328d occurs within a predetermined time interval preceding or following either a rising edge or a falling edge of any of clustered sensor data 328a-328c.

In some implementations, clustered sensor data 328d may be identified, in action 573, by software code 110, executed by hardware processor 104 of system 100. However, in other implementations, clustered sensor data 328d may be identified, in action 573, by software code 210, executed by hardware processor 244 of portable device 240, as described above by reference to FIG. 3.

Referring to FIG. 5 in combination with FIGS. 1, 2, 3 and 4, flowchart 570 further includes processing clustered sensor data 128/228/328a-328d to provide performance data 136/236/(436ab,436ac,436bc) for apparatus 124/224 (action 574). In some implementations, as shown in FIG. 1, processing of clustered sensor data 128 to provide performance data 136 for apparatus 124, in action 574, may be performed by software code 110, executed by hardware processor 104 of system 100. However, as shown in FIG. 2, in other implementations, processing of clustered sensor data 228 to provide performance data 236 for apparatus 224, in action 574, may be performed software code 210, executed by hardware processor 244 of portable device 240.

In some implementations, each of the plurality of database entries included in sensor database 130/230 may further identify an expected timing relationship for clustered sensor data 328a-328c generated by sensor(s) 134/234. In those implementations, the processing of clustered sensor data 128/228/328a-328d, in action 574, to provide performance data 136/236/(436ab,436ac,436bc) may include determining a timing relationship among the data points included in clustered sensor data 328a-328c (e.g., delta times 336ab, 336ac and 336bc), comparing the timing relationship among the data points included in clustered sensor data 328a-328c with an expected timing relationship for data generated by sensor(s) 134/234, and comparing a timing interval between the generation of clustered sensor data 328d and an expected timing of at least one sensor in clustered sensor data 328a-328c with the respective predetermined time interval. That is to say, referring to the specific example shown in FIG. 3, in some implementations, action 574 may include comparing delta times 336ab, 336ac and 336bc with expected values for those time intervals, and comparing the timing of rising edge 364d of clustered sensor data 328d with the expected timing of falling edge 362c of clustered sensor data 328c, and comparing the timing of falling edge 362d of clustered sensor data 328d with the expected timing of rising edge 364b of selected sensor content 328b.

Continuing to refer to FIG. 5 in combination with FIGS. 1, 2, 3 and 4, flowchart 570 further includes predicting, using trained ML model(s) 112/212 and performance data 136/236/(436ab,436ac,436bc), whether apparatus 124/224 is operating anomalously (action 575). It is noted that ML model(s) 112/212 may be trained to receive performance data 136/236/(436ab,436ac,436bc) as input, and to provide prediction 138/238 as an output. In some implementations, as shown in FIG. 1, action 575 may be performed by software code 110, executed by hardware processor 104 of system 100, and using trained ML model(s) 112 to provide prediction 138 regarding anomalous operation by apparatus 124. Alternatively, and as shown in FIG. 2, in some implementations action 575 may be performed by software code 210, executed by hardware processor 244 of portable device 240, and using trained ML model(s) 212 to provide prediction 238 regarding anomalous operation by apparatus 224.

Referring to FIG. 5 in combination with FIGS. 1, 2 and 4, flowchart 570 further includes, outputting, when the predicting performed in action 575 identifies apparatus 124/224 as operating anomalously, notification 160/260 including one or more of visual representations 466A, 466B and 466C (hereinafter “visual representation(s) 466A/466B/466C”) of performance data 136/236/(436ab, 436ac, 436bc) (action 576). In some implementations, as shown in FIG. 1, outputting notification 160 including visual representation(s) 466A/466B/466C, in action 576, may include transmitting, by system 100, notification 160 to portable device 140 via communication network 120 and network communication links 122. In those implementations, action 576 may be performed by software code 110, executed by hardware processor 104 of system 100.

However, in other implementations, as shown in FIG. 2, outputting notification 260 including visual representation(s) 466A/466B/466C, in action 576 may include outputting notification 260 including visual representation(s) 466A/466B/466C to display 250 of portable device 240. In implementations in which action 576 includes outputting notification 260 to display 250, action 576 may be performed by software code 210, executed by hardware processor 244 of portable device 240.

Whether action 576 is performed by system 100 or portable device 140/240, in some implementations, notification 160/260 including visual representation(s) 466A/466B/466C may be output in real-time with respect to receiving global sensor data 126/226 in action 571. It is noted that, as defined for the purposes of the present application, the expression “real-time” refers to latency of a few seconds, such as up to ten seconds, or less. Thus, in some implementations, notification 160/260 including visual representation(s) 466A/466B/466C may be provided to system user 132, in action 576, within ten seconds or less of receipt of global sensor data 126/226 by system 100 or portable device 140/240 in action 571.

It is noted that, in some implementations, the method outlined by flowchart 570 may conclude with action 576 described above for apparatus 124/224. However, and referring to FIGS. 2 and 4 in combination, in other implementations, hardware processor 244 of portable device 240 may further execute software code 210 to render visual representation(s) 466A/466B/466C of performance data 136/236/(436ab,436ac,436bc) for apparatus 124/224 on display 250 of portable device 240.

With respect to the method outlined by FIG. 5, it is emphasized that actions 571, 572, 573, 574 and 575 (hereinafter “actions 571-575”), or actions 571-575 and action 576 (hereinafter “actions 571-576”), may be performed in an automated process from which human involvement may be omitted. Moreover, such an automated process including actions 571-575 or actions 571-576 may be performed iteratively with a predetermined periodicity, such as a predetermined periodicity of less than one minute, for example.

In addition to performing actions 572, 573, 574 and 575 (hereinafter “actions 572-575”), or actions 572-575 and action 576, for apparatus 124/224, actions analogous to actions 572-575 or actions analogous to actions 572-575 and 576 may be performed for some or all other apparatuses included among plurality of apparatuses 114/214 using the same global sensor data 126/226 received in action 571. In other words, hardware processor 104 of system 100 may be configured to execute software code 110, or hardware processor 244 of portable device 240 may be configured to execute software code 210, to perform extracting, identifying, processing and predicting analogous to respective actions 572-575, or to perform extracting, identifying, processing, predicting and outputting analogous to respective actions 572-575 and 576 for one, some, or all of plurality of apparatuses 114/214, including apparatus 124/224, subsequent to receiving global sensor data 126/226.

It is noted that the operational performance of apparatuses may vary over the course of a day, i.e., apparatus performance at night may be different from apparatus performance during daylight hours, may vary seasonally, or may vary due to changes in environmental conditions such as temperature, humidity and the like. These variations in operational performance may result in a prediction of anomalous operation by an apparatus, despite that operational performance being normal in view of the prevailing circumstances. In order to reduce or eliminate false positive predictions of anomalous operation, it may be advantageous or desirable to use human review and correction or affirmation of predictions of anomalous operation to modify ML model(s) 112/212, for example by using reinforcement learning to retrain ML model(s) 112/212 to more accurately identify which sensor data should be clustered when performing anomaly prediction. Thus, in some implementations, in addition to actions 571-576, system 100 or portable device 140/240 may receive feedback data from user 132 correcting or affirming a prediction of anomalous operation, and hardware processor 104 of system 100 may execute software code 110 to modify ML model(s) 112, or hardware processor 244 of portable device 140/240 may execute software code 210 to modify ML model(s) 212, to improve the predictive performance of ML model(s) 112/212 over time.

Furthermore, in addition to actions 571-575, or actions 571-576, in some implementations, hardware processor 104 of system 100 may execute software code 110, or hardware processor 244 of portable device 140/240 may execute software code 210, to perform an intervention when anomalous operation by one or more of plurality of apparatuses 114/214 is predicted by trained ML model(s) 112/212. Such an intervention may include sounding an alarm, by system 100 or portable device 140/240, at an apparatus operating anomalously, shutting down operation of an apparatus operating anomalously by system 100 or portable device 140/240, or modifying the performance of an apparatus operating anomalously by system 100 or portable device 240, to name a few examples.

Thus, present application discloses systems and methods for performing data clustering for ML model-based anomaly prediction that address and overcome the drawbacks and deficiencies in the conventional art by disclosing an automated solution for diagnosing the operational states of complex apparatuses and accurately predicting situations in which those apparatuses are likely to malfunction or fail. The present data clustering for ML model-based anomaly prediction systems and methods advance the state-of-the-art by identifying and extracting data relevant to the operating state of an apparatus from a dataset, processing that relevant data to generate performance data for the apparatus, and using a trained ML model to predict whether the apparatus is operating anomalously based on that performance data. Furthermore, in some implementations, the present solution for performing data clustering for ML model-based anomaly prediction may include performing an intervention when the an anomalous operating state of an apparatus is predicted.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a hardware processor; and
a memory storing a software code, a trained machine learning (ML) model, and a sensor database including a plurality of database entries each associating a respective subset of a plurality of sensors with one of a plurality of apparatuses;
the hardware processor configured to execute the software code to:
receive a global sensor data including data generated by all active sensors of the plurality of sensors;
for a first apparatus of the plurality of apparatuses:
extract from the global sensor data, based on a first database entry for the first apparatus, a first sensor data generated by a first subset of the plurality of sensors associated with the first apparatus;
identify, using the global sensor data, a first other sensor data generated by a sensor of the plurality of sensors not included in the first subset of the plurality of sensors within a respective predetermined time interval of an expected timing of at least one sensor of the first subset of the plurality of sensors;
process the first sensor data and the first other sensor data to provide a first performance data for the first apparatus;
predict, using the trained ML model and the first performance data, whether the first apparatus is operating anomalously; and
output, when predicting identifies the first apparatus as operating anomalously, a notification including a visual representation of the first performance data.

2. The system of claim 1, wherein each of the plurality of database entries further identifies an expected timing relationship for data generated by the respective subset of the plurality of sensors, and wherein to process the first sensor data and the first other sensor data to provide the first performance data the hardware processor is further configured to execute the software code to:
determine a timing relationship among the data points included in the first sensor data;
compare the timing relationship among the data points included in the first sensor data with an expected timing relationship for data generated by the first subset of the plurality of sensors; and
compare a timing interval between the generation of the first other sensor data and an expected timing of the at least one sensor in the first sensor data with the respective predetermined time interval.

3. The system of claim 1, wherein the hardware processor is further configured to execute the software code to:
for each apparatus of the plurality of apparatuses other than the first apparatus:
extract from the global sensor data, based on a database entry for that apparatus, sensor data generated by a subset of the plurality of sensors associated with that apparatus;
identify, using the global sensor data, another sensor data generated by a sensor of the plurality of sensors not included in the subset of the plurality of sensors associated with that apparatus within a respective predetermined time interval of an expected timing of at least one sensor of the subset of the plurality of sensors associated with that apparatus;
process the sensor data generated by the subset of the plurality of sensors associated with that apparatus and the another sensor data to provide a performance data for that apparatus;
predict, using the trained ML model and the performance data, whether that apparatus is operating anomalously; and
output, when predicting identifies that apparatus as operating anomalously, another notification including a visual representation of the performance data for that apparatus.

4. The system of claim 1, wherein the hardware processor is further configured to execute the software code to receive the global sensor data, and to perform the extracting, identifying, processing, and predicting for the first apparatus in an automated process having a predetermined periodicity.

5. The system of claim 4, wherein the predetermined periodicity is less than one minute.

6. The system of claim 1, wherein the global sensor data comprises billions of data points.

7. The system of claim 6, wherein the global sensor data comprises binary time series data.

8. The system of claim 1, wherein the plurality of sensors are digital sensors.

9. The system of claim 1, further comprising:
a display;
wherein the hardware processor is further configured to execute the software code to:
render the visual representation of the performance data on the display.

10. The system of claim 1, wherein the first apparatus comprises one of a baggage claim carousel, an automated warehouse, a theme park attraction, a vehicle assembly line machine, an aviation system, a HVAC system, an engine, a manufacturing equipment, or a computer server.

11. A method for use by a system including a hardware processor and a memory storing a software code, a trained machine learning (ML) model, and a sensor database including a plurality of database entries each associating a respective subset of a plurality of sensors with one of a plurality of apparatuses, the method comprising:
receiving, by the software code executed by the hardware processor, a global sensor data including data generated by all active sensors of the plurality of sensors;
for a first apparatus of the plurality of apparatuses:
extracting from the global sensor data,, by the software code executed by the hardware processor based on a first database entry for the first apparatus, a first sensor data generated by a first subset of the plurality of sensors associated with the first apparatus;
identifying,, by the software code executed by the hardware processor and using the global sensor data, a first other sensor data generated by a sensor of the plurality of sensors not included in the first subset of the plurality of sensors within a respective predetermined time interval of an expected timing of at least one sensor of the first subset of the plurality of sensors;
processing the first sensor data and the first other sensor data, by the software code executed by the hardware processor, to provide a first performance data for the first apparatus;
predicting,, by the software code executed by the hardware processor using the trained ML model and the first performance data, whether the first apparatus is operating anomalously; and
outputting, by the software code executed by the hardware processor when predicting identifies the first apparatus as operating anomalously, a notification including a visual representation of the first performance data.

12. The method of claim 11, wherein each of the plurality of database entries further identifies an expected timing relationship for data generated by the respective subset of the plurality of sensors, and wherein processing the first sensor data and the first other sensor data to provide the first performance data further comprises:
determining, by the software code executed by the hardware processor, a timing relationship among the data points included in the first sensor data;
comparing, by the software code executed by the hardware processor, the timing relationship among the data points included in the first sensor data with an expected timing relationship for data generated by the first subset of the plurality of sensors; and
comparing, by the software code executed by the hardware processor, a timing interval between the generation of the first other sensor data and an expected timing of the at least one sensor in the first sensor data with the respective predetermined time interval.

13. The method of claim 11, wherein the hardware processor is further configured to execute the software code to:
for each apparatus of the plurality of apparatuses other than the first apparatus:
extracting from the global sensor data, by the software code executed by the hardware processor based on a database entry for that apparatus, sensor data generated by a subset of the plurality of sensors associated with that apparatus;
identifying, by the software code executed by the hardware processor and using the global sensor data, another sensor data generated by a sensor of the plurality of sensors not included in the subset of the plurality of sensors associated with that apparatus within a respective predetermined time interval of an expected timing of at least one sensor of the subset of the plurality of sensors associated with that apparatus;
processing the sensor data generated by the subset of the plurality of sensors associated with that apparatus and the another sensor data, by the software code executed by the hardware processor, to provide a performance data for that apparatus;
predicting, by the software code executed by the hardware processor and using the trained ML model and the performance data, whether that apparatus is operating anomalously; and
outputting, by the software code executed by the hardware processor when predicting identifies that apparatus as operating anomalously, another notification including a visual representation of the performance data for that apparatus.

14. The method of claim 11, wherein receiving the global sensor data, and perform the extracting, identifying, processing, and predicting for the first apparatus is performed in an automated process having a predetermined periodicity.

15. The method of claim 14, wherein the predetermined periodicity is less than one minute.

16. The method of claim 11, wherein the global sensor data comprises billions of data points.

17. The method of claim 16, wherein the global sensor data comprises binary time series data.

18. The method of claim 11, wherein the plurality of sensors are digital sensors.

19. The method of claim 11, wherein the system further comprises a display, the method further comprising:
rendering, by the software code executed by the hardware processor, the visual representation of the performance data on the display.

20. The method of claim 11, wherein the first apparatus comprises one of a baggage claim carousel, an automated warehouse, a theme park attraction, a vehicle assembly line machine, an aviation system, a HVAC system, an engine, a manufacturing equipment, or a computer server.
